(19) United States
(12) Patent Application Publication
(10) Pub. No.: US 2024/0419478 A1
(43) Pub. Date: Dec. 19, 2024

(54) VIRTUAL MACHINE OPERATING SYSTEM DEVICE ASSIGNMENT SYSTEM AND ASSOCIATED METHOD AND NON-TRANSITORY MACHINE-READABLE MEDIUM

(71) Applicant: MEDIATEK INC., Hsin-Chu (TW)

(72) Inventors: Chih-Hsiang Hsiao, Hsinchu City (TW); Ze-Yu Wang, Hsinchu City (TW); Yi-De Wu, Hsinchu City (TW); Yu-Chi Chu, Hsinchu City (TW)

(73) Assignee: MEDIATEK INC., Hsin-Chu (TW)

(21) Appl. No.: 18/743,104

(22) Filed: Jun. 14, 2024

Related U.S. Application Data
(60) Provisional application No. 63/508,013, filed on Jun. 14, 2023.

(51) Int. Cl. G06F 9/455; G06F 9/4401

(52) U.S. Cl. CPC G06F 9/45558; G06F 9/4401; G06F 2009/45575

(57) ABSTRACT

A virtual machine (VM) operating system (OS) device assignment system includes a processor, wherein the processor is configured to execute a host VM, a hypervisor, a device assigner, and a guest VM. The host VM is arranged to generate a driving signal for driving a booting of the guest VM. The hypervisor is arranged to generate a first trigger signal according to the driving signal, for triggering assignment of at least one device. The device assigner is arranged to modify a descriptor to generate a modified descriptor for assigning the at least one device among a plurality of devices to the guest VM, and install the modified descriptor into a protected memory, wherein an OS of the guest VM is configured according to the modified descriptor.

### CROSS REFERENCE TO RELATED APPLICATIONS

This application claims the benefit of U.S. Provisional Application No. 63/508,013, filed on Jun. 14, 2023. The content of the application is incorporated herein by reference.

### BACKGROUND

The present invention is related to virtualization, and more particularly, to a virtual machine (VM) operating system (OS) device assignment system, an associated method, and an associated non-transitory machine-readable medium.

For an edge device (e.g. a mobile phone or a tablet) running with a Linux kernel, the edge device provides a virtualization framework based on security considerations. The virtualization framework uses a hypervisor to generate multiple guest VMs, wherein the guest VMs are protected by hardware in the edge device to avoid being attacked, each of the guest VMs can run its own OS, and the Linux therein will use a descriptor file (e.g. a device tree blob, dtb) to describe a platform of the edge device (e.g. the hardware resource of the edge device, such as the size and the location of a central processing unit (CPU) or a memory). Different guest VMs may require support from different devices. However, due to the limited resources of the platform, the devices cannot be used by each guest VM. Therefore, a method for dynamically assigning devices to the guest VM is urgently needed.

### SUMMARY

It is therefore one of the objectives of the present invention to provide a VM OS device assignment system, associated method, and an associated non-transitory machine-readable medium, to address the above-mentioned issues.

According to an embodiment of the present invention, a VM OS device assignment system is provided. The VM OS device assignment system comprises a processor, wherein the processor is configured to execute a host VM, a hypervisor, a device assigner, and a guest VM. The host VM is arranged to generate a driving signal for driving a booting of the guest VM. The hypervisor is arranged to generate a first trigger signal according to the driving signal, for triggering assignment of at least one device among a plurality of devices. The device assigner is arranged to modify a descriptor file to generate a modified descriptor file for assigning the at least one device to the guest VM, and install the modified descriptor file into a protected memory, wherein an OS of the guest VM is configured according to the modified descriptor file.

According to an embodiment of the present invention, a VM OS device assignment method is provided. The VM OS device assignment method includes: modifying, by a device assigner, a descriptor file to generate a modified descriptor file for assigning at least one device among a plurality of devices to a guest VM; installing, by the device assigner, the modified descriptor file into a protected memory before booting an OS of the guest VM; and configuring the OS of the guest VM according to the modified descriptor file.

According to an embodiment of the present invention, a non-transitory machine-readable medium for storing a program code is provided, wherein when loaded and executed by a processor, the program code instructs the processor to execute a host VM, a hypervisor, a device assigner, and a guest VM. The host VM is arranged to generate a driving signal for driving a booting of the guest VM. The hypervisor is arranged to generate a first trigger signal according to the driving signal, for triggering assignment of at least one device among a plurality of devices. The device assigner is arranged to modify a descriptor file to generate a modified descriptor file for assigning the at least one device to the guest VM, and install the modified descriptor file into a protected memory, wherein an OS of the guest VM is configured according to the modified descriptor file.

One of the benefits of the present invention is that, by the VM OS device assignment system of the present invention, a dtb can be modified to dynamically assign (e.g. add) at least one device on a platform to a guest VM, and more particularly, a device assigner that is independent of a hypervisor (e.g. an APP or a VM generated by the hypervisor) can be utilized to modify the dtb for performing the assignment of the at least one device, without changing configuration associated with the hypervisor. In this way, security of an electronic device on which the VM OS device assignment system is embodied and user convenience can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a guest VM OS device assignment system according to an embodiment of the present invention.

FIG. 3 is a diagram illustrating a guest VM OS device assignment system according to another embodiment of the present invention.

FIG. 4 is a diagram illustrating a guest VM OS device assignment system according to yet another embodiment of the present invention.

FIG. 5 is a flow chart of a guest VM OS device assignment method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

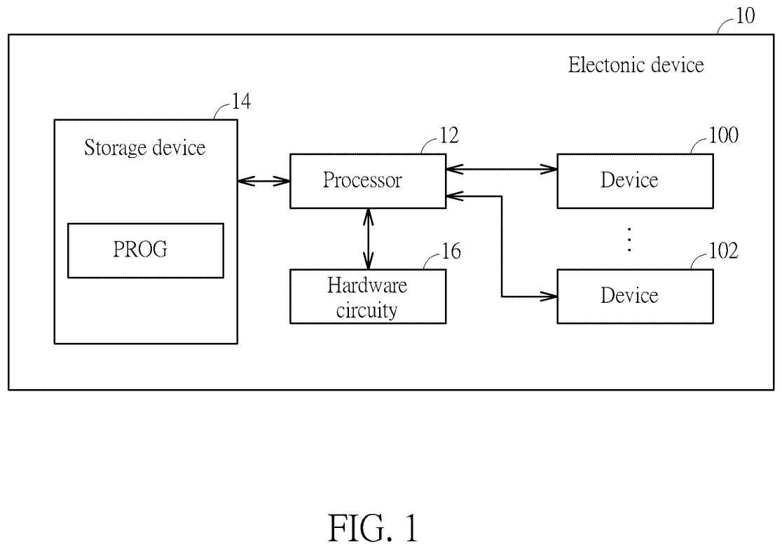

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12, a storage device 14, a hardware circuitry 16, and a plurality of devices 100 and 102. Examples of each of the devices 100 and 102 may include, but are not limited to: a central processing unit (CPU), a graphics processing unit (GPU), and a camera. For clarity and simplicity, only two devices 100 and 102 are illustrated in FIG. 1. In practice, the electronic device 10 may have more than two devices, depending upon actual design considerations. The processor 12 may be a single-core processor or a multi-core processor. The storage device 14 is a computer-readable medium, and is arranged to store computer program code PROG. The processor 12 is equipped with software execution capability. The computer program code PROG may include a plurality of software modules. Hence, when loaded and executed by the processor 12, the computer program code PROG instructs the processor 12 to perform designated functions of the software modules. The electronic device 10 may be regarded as a computer system using a computer program product that includes a computer-readable medium containing the computer program code PROG. The hardware circuitry 16 is pure hardware that may consist of logic gates only, and performs designated functions without software execution. Regarding a guest virtual machine (VM) operating system (OS) device assignment system as proposed by the present invention, it may be embodied on the electronic device 10. For example, the guest VM OS device assignment system may include software-based functions implemented by computer program code PROG running on the processor 12 and/or hardware-based functions implemented by the hardware circuitry 16.

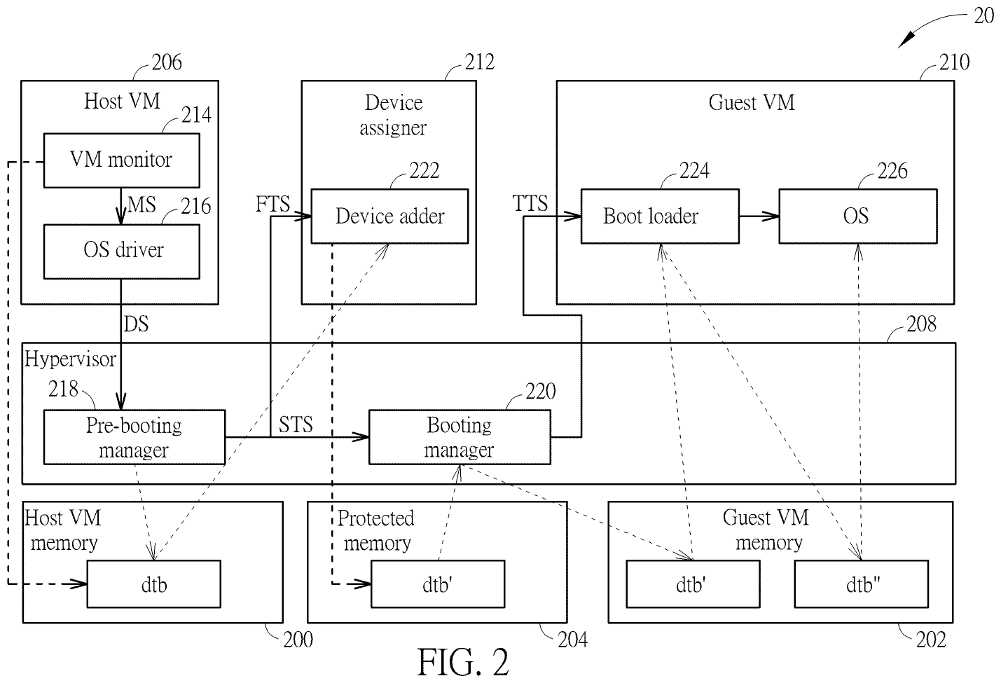

FIG. 2 is a diagram illustrating a guest VM OS device assignment system 20 according to an embodiment of the present invention. The guest VM OS device assignment system 20 may include a processor (e.g. the processor 12 shown in FIG. 1), a host VM memory 200, a guest VM memory 202, and a protected memory 204. The processor may be configured to execute software modules, including a host VM 206 and a hypervisor 208. When there is a need, at least one guest VM can be dynamically generated by the hypervisor 208. In this embodiment, the processor may be configured to execute a guest VM 210 generated by the hypervisor 208. This is for illustration only, and the present invention is not limited thereto. In some embodiments, more than one guest VM may be executed by the processor, depending upon design requirements. In addition, the processor may be further configured to execute a device assigner 212 that is a software module. The device assigner 212 is protected to avoid being attacked, such as attacks from the host VM. For example, the device assigner 212 may be a protected VM generated by the hypervisor 208, however, the present invention is not limited thereto. In some embodiments, the device assigner 212 may be implemented by a protected application (APP) generated by the hypervisor 208.

As shown in FIG. 2, the host VM 206 may include a VM monitor 214 and an OS driver 216 (e.g. a Linux driver), wherein the VM monitor 214 may be arranged to generate a monitor signal MS in response to the guest VM 210 being required to be generated, and the OS driver 216 may be arranged to generate a driving signal DS according to the monitor signal MS, for driving a booting of the guest VM 210 (e.g. driving an OS 226 of the guest VM 210, such as a Linux of the guest VM 210). In addition, the host VM 206 (more particularly, the VM monitor 214) may be further arranged to store a descriptor file (e.g. a device tree blob, dtb) in the host VM memory 200. In one example, the descriptor file may include a template, and the template may include a blank field corresponding to a device. The blank field has not been written to and may be filled with resource configuration information of the device. The resource configuration information may include a register location of the device, for example, a register address of the device. This is merely an example and the present invention is not limited to this example. Alternatively, in another example, the descriptor file may comprise a template, and the template may include a field corresponding to a device. The resource configuration information of the device has been written into the field by the host VM. It is noted that the resource configuration information of the device may be incorrect because the host VM is not protected and may be attacked. For example, assume that the guest VM needs a camera, and the host VM provides a template for the camera. It should be noted that in some embodiments, the dtb stored in the host VM memory 200 may be provided by a network or other APP running on the processor.

The hypervisor 208 may include a pre-booting manager 218 and a booting manager 220. The pre-booting manager 218 may be arranged to receive the driving signal DS from the OS driver 216, and generate and output a first trigger signal FTS to the device assigner 212 according to the driving signal DS, for triggering the device assigner 212 to assign at least one device among the devices 100 and 102 for the guest VM 210. The device assigner 212 may include a device adder 222, wherein the device adder 222 may be arranged to obtain the dtb from the host VM memory 200 and perform the assignment operation. Specifically, the device assigner 212 (more particularly, the device adder 222) may modify the dtb to generate a modified dtb (denoted by “dtb′”) for assigning (e.g. adding) the at least one device to the guest VM 210 based on the requirement of the guest VM 210.

For example, the device assigner 212 may determine which devices are to be assigned to guest VM 210, and write resource configuration information related to the determined device to the dtb to generate a modified dtb (denoted by “dtb′”). For example, the device assigner 212 may select a camera based on the requirement of the guest VM 210, and write resource configuration information of the selected camera to the template of the camera in the dtb.

Alternatively, the pre-booting manager 218 may be arranged to obtain the dtb from the host VM memory and modify the resource configuration information of the device in the template of the device to a default value. For example, the pre-booting manager 218 may be arranged to modify the register address of the device to 0x0 0x0 0x0 0x0. The device assigner 212 may determine which devices are to be assigned to guest VM 210, and write resource configuration information related to the determined device to the template of the device to generate a modified dtb (denoted by “dtb′”). For example, the device assigner 212 may select a camera based on the requirement of the guest VM 210, and write resource configuration information of the selected camera to the template of the camera in the dtb. Therefore, the register address 0x0 0x0 0x0 0x0 of the camera in the template may be modified to a correct address.

After the dtb′ is generated, the device assigner 212 may install (e.g. store) the dtb′ into the protected memory 204, wherein the OS 226 of the guest VM 210 is configured according to the dtb′.

After the dtb′ is installed into the protected memory 204, the pre-booting manager 218 may be further arranged to generate and output a second trigger signal STS to the booting manager 220 for triggering the booting of the guest VM 210. The booting manager 220 may be arranged to perform the booting of the guest VM 210 according to the second trigger signal STS. Specifically, the booting manager 220 may obtain the dtb′ from the protected memory 204, transfer the dtb′ to the guest VM memory 202, and generate and output a third trigger signal TTS to the guest VM 210 for triggering subsequent processing. The guest VM 210 may include a boot loader 224. After receiving the third trigger signal TTS, the boot loader 224 may be arranged to obtain the dtb′ from the guest VM memory 202, and perform a check operation upon the dtb′, to generate a checked dtb (denoted by “dtb″”) for storing in the guest VM memory 202. The boot loader 224 may check whether devices assigned in dtb′ are required devices. For example, under a condition that it is checked that there is no error in the dtb′, some security-related nodes can be added to the dtb′ to generate the dtb″. The security-related node may include a key. The OS 226 of the guest VM 210 may be configured based on the dtb″ stored in the guest VM memory 202.

In this embodiment, the guest VM 210, the guest VM memory 202, the protected memory 204, the hypervisor 208, and the device assigner 212 are protected to avoid being attacked, such as protected by a firewall.

It is noted that the host VM also may transfer the dtb to the pre-booting manager in the hypervisor instead of transferring the dtb to the host VM memory. Then, the pre-booting manager may modify the resource configuration information of the device in the template of the device to a default value.

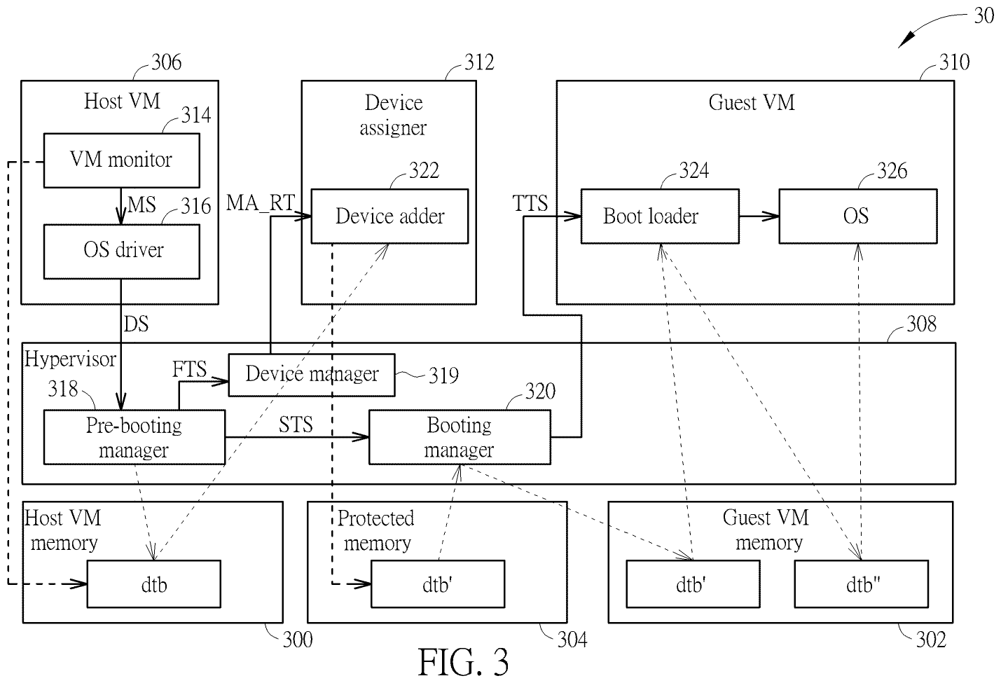

FIG. 3 is a diagram illustrating a guest VM OS device assignment system 30 according to another embodiment of the present invention. The guest VM OS device assignment system 30 may include a processor (e.g. the processor 12 shown in FIG. 1), a host VM memory 300, a guest VM memory 302, and a protected memory 304. The processor may be arranged to execute software modules, including a host VM 306 and a hypervisor 308, wherein the host VM 306 may include a VM monitor 314 and an OS driver 316, and the hypervisor 308 may include a pre-booting manager 318 and a booting manager 320. When there is a need, at least one guest VM can be dynamically generated by the hypervisor 308. In this embodiment, the processor may be arranged to execute a guest VM 310 generated by the hypervisor 308, wherein the guest VM 310 may include a boot loader 324 and an OS 326. The difference between the guest VM OS device assignment system 30 and the guest VM OS device assignment system 20 shown in FIG. 2 is that the hypervisor 308 of the guest VM OS device assignment system 30 further includes a device manager 319.

The device assigner 312 (more particularly, a device adder 322 included in the device assigner 312) is not capable of managing the devices 100 and 102. Therefore, in response to the generation requirements of the guest VM 310, the pre-booting manager 318 may be arranged to generate and output the first trigger signal FTS to the device manager 319, and the device manager 319 may be arranged to manage the devices 100 and 102, and transmit a management result MA RT to the device assigner 312 (more particularly, the device adder 322). For example, the device manager 319 may store information related to which devices have been assigned and which devices are unassigned, wherein the unassigned devices are available devices. The management result MA RT transmitted from the device manager 319 to the device assigner 312 may include the information related to the unassigned devices. For example, there are four cameras. One camera has been assigned to another guest VM, and three cameras have not been assigned. The device adder 322 may be arranged to obtain the dtb from the host VM memory 300, and perform an assignment operation based on the management result MA RT. Since the operations of the guest VM OS device assignment system 30 are similar to that of the guest VM OS device assignment system 20 shown in FIG. 2, similar descriptions for this embodiment are not repeated in detail here for brevity.

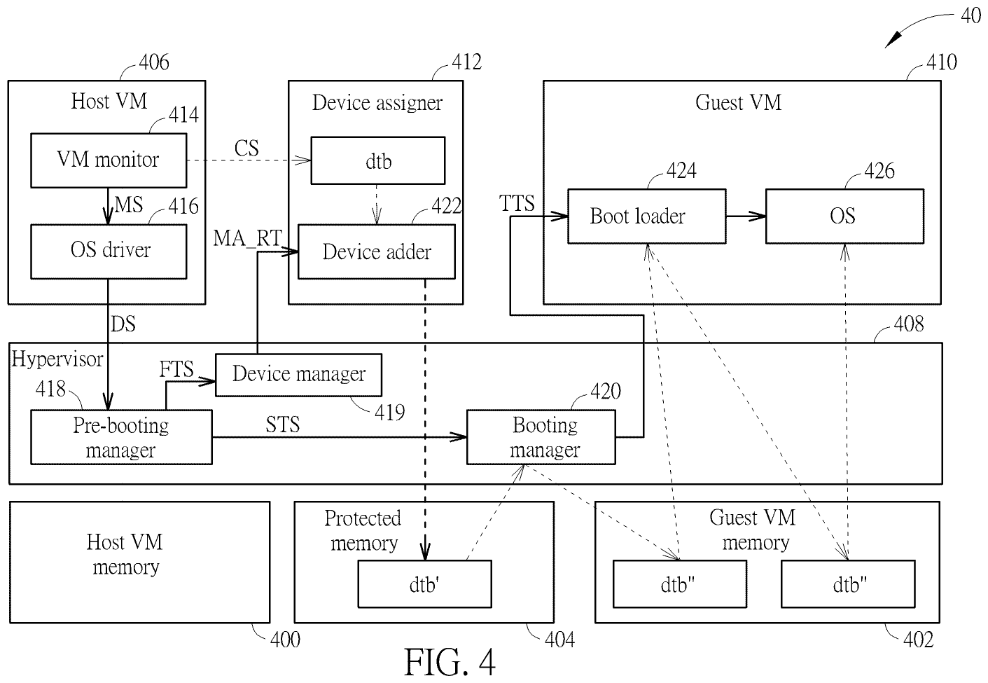

FIG. 4 is a diagram illustrating a guest VM OS device assignment system 40 according to yet another embodiment of the present invention. As shown in FIG. 4, the guest VM OS device assignment system 40 may include a processor (e.g. the processor 12 shown in FIG. 1), a host VM memory 400, a guest VM memory 402, and a protected memory 404. The processor may be arranged to execute software modules, including a host VM 406 and a hypervisor 408, wherein the host VM 406 may include a VM monitor 414 and an OS driver 416, and the hypervisor 408 may include a pre-booting manager 418 and a booting manager 420. When there is a need, at least one guest VM can be dynamically generated by the hypervisor 408. In this embodiment, the processor may be arranged to execute a guest VM 410 generated by the hypervisor 408, wherein the guest VM 410 may include a boot loader 424. In addition, the processor may be further arranged to execute a device assigner 412, wherein the device assigner 412 may be a protected VM or a protected APP generated by the hypervisor 408.

In response to the guest VM 410 being required to be generated, the VM monitor 414 may be arranged to generate and output a monitor signal MS to the OS driver 416, and the OS driver 416 may be arranged to generate a driving signal DS according to the monitor signal MS, for driving a booting of the guest VM 410 (e.g. driving an OS 426 of the guest VM 410, such as a Linux of the guest VM 410). The device assigner 412 may include a base descriptor file (e.g. a dtb) and a device adder 422, wherein the device adder 422 may be arranged to perform the assignment of the at least one device. In addition, the VM monitor 414 may be further arranged to generate and output a control signal CS to the device assigner 412 for controlling the device assigner 412 to inject the dtb into the device adder 422.

The pre-booting manager 418 may receive the driving signal DS, and generate and output a first trigger signal FTS to the device manager 419. The device manager 419 may be arranged to transmit a management result MA RT to the device assigner 412 (more particularly, the device adder 422). For example, the device manager 419 may store information related to which devices have been assigned and which devices are unassigned, wherein the unassigned devices are available devices. The management result MA RT transmitted from the device manager 419 to the device assigner 412 may include the information related to the unassigned devices. The device adder 422 in the device assigner 412 may perform an assignment operation based on the management result MA RT after the dtb is injected into the device adder 422.

Since the operations of the guest VM OS device assignment system 40 are similar to that of the guest VM OS device assignment system 30 shown in FIG. 3, similar descriptions for this embodiment are not repeated in detail here for brevity.

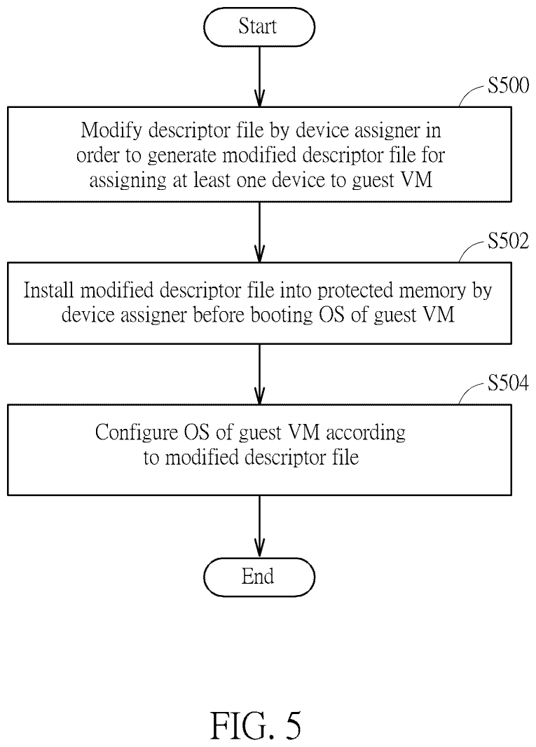

FIG. 5 is a flow chart of a guest VM OS device assignment method according to an embodiment of the present invention. Provided that the result is substantially the same, the steps are not required to be executed in the exact order shown in FIG. 5. For example, the guest VM OS device assignment method shown in FIG. 5 may be employed by the guest VM OS device assignment systems 20/30/40 shown in FIGS. 2, 3 and 4.

In Step S500, a descriptor file (e.g., a dtb) is modified by a device assigner in order to generate a modified descriptor file for assigning at least one device to a guest VM.

In Step S502, the modified descriptor file is installed into a protected memory by the device assigner before booting an OS of the guest VM.

In Step S504, the OS of the guest VM is configured according to the modified descriptor file.

Since a person skilled in the pertinent art can readily understand details of the steps after reading above paragraphs directed to the guest VM OS device assignment systems 20/30/40 shown in FIGS. 2, 3 and 4, further descriptions are omitted here for brevity.

In summary, by the guest VM OS device assignment system of the present invention, a dtb can be modified to dynamically assign (e.g. add) at least one device on a platform to a guest VM, and more particularly, a device assigner that is independent of a hypervisor (e.g. an protected APP or a protected VM generated by the hypervisor) can be utilized to modify the dtb for performing the assignment of the at least one device, without changing configuration associated with the hypervisor. In this way, security of an electronic device on which the guest VM OS device assignment system is embodied and user convenience can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A virtual machine (VM) operating system (OS) device assignment system, comprising:
a processor, configured to execute:
a host VM, arranged to generate a driving signal for driving a booting of a guest VM;
a hypervisor, arranged to generate a first trigger signal according to the driving signal, for triggering assignment of at least one device among a plurality of devices for the guest VM;
a device assigner, arranged to modify a descriptor file to generate a modified descriptor file for assigning the at least one device to the guest VM, and install the modified descriptor file into a protected memory; and
the guest VM, wherein an OS of the guest VM is configured according to the modified descriptor file.

2. The VM OS device assignment system of claim 1, wherein the host VM comprises:
a VM monitor, arranged to generate a monitor signal in response to the guest VM being required to be generated; and
an OS driver, arranged to generate the driving signal according to the monitor signal.

3. The VM OS device assignment system of claim 1, wherein the host VM is further arranged to provide the descriptor file to a host VM memory, and the device assigner is further arranged to obtain the descriptor file from the host VM memory.

4. The VM OS device assignment system of claim 1, wherein the hypervisor comprises a device manager, and the device manager is arranged to manage the plurality of devices, and transmit a management result to the device assigner for the assignment of the at least one device according to the first trigger signal, wherein the management result comprises information related to unassigned devices among the plurality of devices.

5. The VM OS device assignment system of claim 1, wherein the hypervisor comprises:
a pre-booting manager, arranged to:
generate the first trigger signal according to the driving signal; and
after the modified descriptor file is installed into the protected memory, generate a second trigger signal for triggering the booting of the guest VM; and
a booting manager, arranged to receive the second trigger signal, and perform the booting of the guest VM according to the second trigger signal.

6. The VM OS device assignment system of claim 1, wherein the device assigner is a VM generated by the hypervisor.

7. The VM OS device assignment system of claim 1, wherein the device assigner is implemented by an application (APP) generated by the hypervisor.

8. The VM OS device assignment system of claim 1, wherein the guest VM comprises:
a boot loader, arranged to perform a check operation upon the modified descriptor file, to generate a checked descriptor file;
wherein the OS of the guest VM is configured according to the checked descriptor file.

9. The VM OS device assignment system of claim 1, wherein the device assigner comprises the descriptor file and a device adder, the device adder is arranged to perform the assignment of the at least one device, and the host VM is further arranged to generate and output a control signal to the device assigner for controlling the device assigner to inject the descriptor file into the device adder.

10. The VM OS device assignment system of claim 9, wherein the hypervisor comprises a device manager, and the device manager is arranged to manage the plurality of devices, and transmit a management result to the device adder for the assignment of the at least one device according to the first trigger signal, wherein the management result comprises information related to unassigned devices among the plurality of devices.

11. A virtual machine (VM) operating system (OS) device assignment method, comprising:
modifying, by a device assigner, a descriptor file to generate a modified descriptor file for assigning at least one device among a plurality of devices to a guest VM;
installing, by the device assigner, the modified descriptor file into a protected memory before booting an OS of the guest VM; and
configuring the OS of the guest VM according to the modified descriptor file.

12. The VM OS device assignment method of claim 11, further comprising:
providing the descriptor file to a host VM memory by utilizing a host VM; and
obtaining, by the device assigner, the descriptor file from the host VM memory.

13. The VM OS device assignment method of claim 11, wherein the step of modifying, by the device assigner, the descriptor file to generate the modified descriptor file comprises:
receiving, by the device assigner, a management result from a hypervisor, wherein the management result comprises information related to unassigned devices in the plurality of devices; and
modifying the descriptor file according to the management result to generate the modified descriptor file.

14. The VM OS device assignment method of claim 11, further comprising:
receiving, by the device assigner, a control signal from a host VM;
wherein the step of modifying, by the device assigner, the descriptor file to generate the modified descriptor file comprises:
obtaining the descriptor file after the control signal is received, and modifying the descriptor file to generate the modified descriptor file.

15. The VM OS device assignment method of claim 11, further comprising:
transferring the modified descriptor file from the protected memory to a guest VM memory of the guest VM by utilizing a hypervisor.

16. The VM OS device assignment method of claim 11, wherein the device assigner is a VM generated by a hypervisor or an application (APP) generated by the hypervisor.

17. A non-transitory machine-readable medium for storing a program code, wherein when loaded and executed by a processor, the program code instructs the processor to execute:
a host VM, arranged to generate a driving signal for driving a booting of a guest VM;
a hypervisor, arranged to generate a first trigger signal according to the driving signal, for triggering assignment of at least one device among a plurality of devices for the guest VM;
a device assigner, arranged to modify a descriptor file according to the first trigger signal to generate a modified descriptor file for assigning the at least one device to the guest VM, and install the modified descriptor file into a protected memory; and
the guest VM, wherein an OS of the guest VM is configured according to the modified descriptor file.

18. The non-transitory machine-readable medium of claim 17, wherein the host VM is further arranged to provide the descriptor file to a host VM memory, and the device assigner is further arranged to obtain the descriptor file from the host VM memory.

19. The non-transitory machine-readable medium of claim 17, wherein the hypervisor comprises a device manager, and the device manager is arranged to manage the plurality of devices and store a management result, and transmit the management result to the device assigner for the assignment of the at least one device according to the first trigger signal, wherein the management result comprises information related to unassigned devices among the plurality of devices.

20. The non-transitory machine-readable medium of claim 17, wherein the device assigner comprises the descriptor file and a device adder, and the device adder is arranged to perform the assignment of the at least one device, and the host VM is further arranged to generate and output a control signal to the device assigner for controlling the device assigner to inject the descriptor into the device adder.
